(19) United States
(12) Patent Application Publication
(10) Pub. No.: US 2021/0086452 A1
(43) Pub. Date: Mar. 25, 2021

(54) SYSTEM FOR ADDITIVELY MANUFACTURING A STRUCTURE

(71) Applicant: Continuous Composites Inc., Coeur d'Alene, ID (US)

(72) Inventor: Rachael Kathleen MORRIS, Greenacres, WA (US)

(73) Assignee: Continuous Composites Inc, Coeur d'Alene, ID (US)

(21) Appl. No.: 16/947,387

(22) Filed: Jul. 30, 2020

Related U.S. Application Data
(60) Provisional application No. 62/904,999, filed on Sep. 24, 2019.

(51) Int. Cl. B29C 64/393; B29C 64/245; B29C 64/209; B29C 64/188; B29C 64/40

(52) U.S. Cl. CPC B29C 64/393; B29C 64/245; B33Y 10/00; B29C 64/188; B29C 64/40; B29C 64/209

(57) ABSTRACT

A system is disclosed for additively manufacturing a structure. The system may include a support, a platform, and a print head connected to and moveable by the support. The print head may be configured to discharge a material onto the platform to build up a structure in an axial direction away from the platform. The system may also include a controller programmed to determine a threshold height of the structure in the axial direction at which continued discharge of the material from the print head will cause the structure to deviate from a desired location in a radial direction that is orthogonal to the axial direction, and to coordinate operation of the print head with operation of the support to fabricate at least one support that extends away from the structure at the threshold height to resist deviation of the structure from the desired location in the radial direction.

### RELATED APPLICATION

This application is based on and claims the benefit of priority from U.S. Provisional Application No. 62/904,999 that was filed on Sep. 24, 2019, the contents of which are expressly incorporated herein by reference.

### TECHNICAL FIELD

The present disclosure relates generally to a manufacturing system and, more particularly, to a system for additively manufacturing a structure.

### BACKGROUND

Continuous fiber 3D printing (a.k.a., CF3D®) involves the use of continuous fibers embedded within a matrix discharging from a moveable print head. The matrix can be a traditional thermoplastic, a powdered metal, a liquid resin (e.g., a UV curable and/or two-part resin), or a combination of any of these and other known matrixes. Upon exiting the print head, a head-mounted cure enhancer (e.g., a UV light, an ultrasonic emitter, a heat source, a catalyst supply, etc.) is activated to initiate and/or complete curing of the matrix. This curing occurs almost immediately, allowing for unsupported structures to be fabricated in free space. When fibers, particularly continuous fibers, are embedded within the structure, a strength of the structure may be multiplied beyond the matrix-dependent strength. An example of this technology is disclosed in U.S. Pat. No. 9,511,543 that issued to Tyler on Dec. 6, 2016 (“the '543 patent”).

Although CF3D® provides for increased strength, compared to manufacturing processes that do not utilize continuous fiber reinforcement, improvements can be made to the structure and/or operation of existing systems. For example, Applicant has found that, when fabricating high-aspect ratio structures, flexibility within the structures during fabrication can cause fiber misalignments between overlapping layers and a general reduction in fiber placement accuracy. The disclosed additive manufacturing system is uniquely configured to provide these improvements and/or to address other issues of the prior art.

### SUMMARY

In one aspect, the present disclosure is directed to an additive manufacturing system. The additive manufacturing system may include a support, a platform, a print head connected to and moveable by the support. The print head may be configured to discharge a material onto the platform to build up a structure in an axial direction away from the platform. The additive manufacturing system may also include a controller in communication with the support and the print head. The controller may be programmed to determine a threshold height of the structure in the axial direction at which continued discharge of the material from the print head will cause the structure to deviate from a desired location in a radial direction that is orthogonal to the axial direction. The controller may also be programmed to coordinate operation of the print head with operation of the support to fabricate at least one support that extends away from the structure at the threshold height to resist deviation of the structure from the desired location in the radial direction.

In another aspect, the present disclosure is directed to a method of additive manufacturing. The method may include discharging a material from a print head onto a platform to build up the structure in an axial direction away from the platform. The method may also include determining a threshold height of the structure away from the platform at which continued discharging of the material from the print head will cause the structure to deviate in a radial direction from a desired location. The radial direction may be orthogonal to the axial direction. The method may further include causing the print head to fabricate at least one support that extends away from the structure at the threshold height to resist deviation of the structure in the radial direction.

### BRIEF DESCRIPTION OF THE DRAWINGS

FIG. 1 is a diagrammatic illustration of an exemplary disclosed additive manufacturing system; and

FIGS. 2 and 3 are flowcharts depicting exemplary disclosed methods of controlling the additive manufacturing system of FIG. 1.

### DETAILED DESCRIPTION

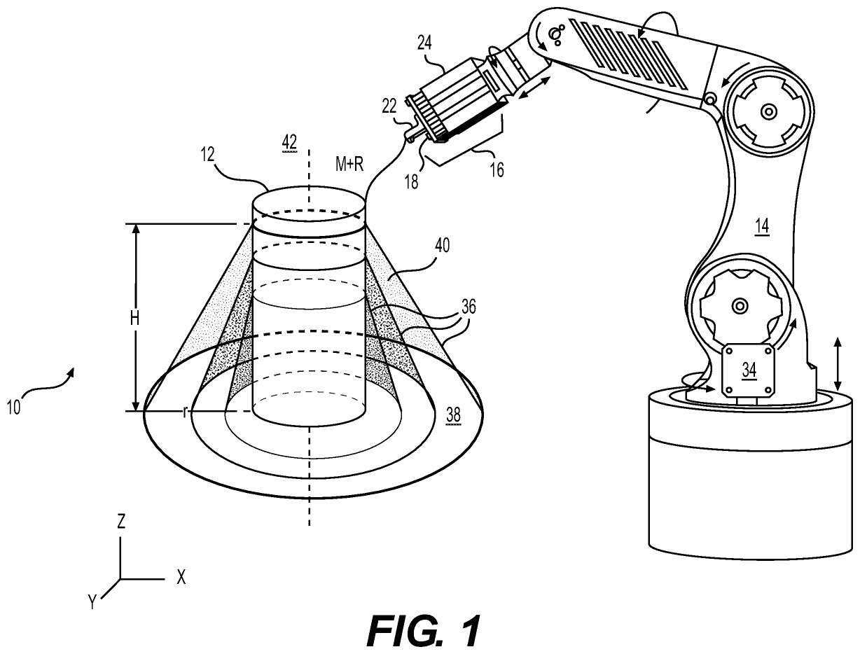

FIG. 1 illustrates an exemplary system 10, which may be used to manufacture a composite structure 12 having any desired shape. System 10 may include a support 14 and a deposition head (“head”) 16. Head 16 may be coupled to and moved by support 14. In the disclosed embodiment of FIG. 1, support 14 is a robotic arm capable of moving head 16 in multiple directions during fabrication of structure 12. Support 14 may alternatively embody a gantry (e.g., an overhead-bridge gantry or a single-post gantry) or a hybrid gantry/arm also capable of moving head 16 in multiple directions during fabrication of structure 12. Although support 14 is shown as being capable of 6-axis movements relative to structure 12, it is contemplated that support 14 may be capable of moving head 16 in a different manner (e.g., along and/or around a greater or lesser number of axes). It is also contemplated that structure 12 could be associated with one more movement axis and configured to move independent of and/or in coordination with support 14. In some embodiments, a drive may mechanically couple head 16 to support 14, and include components that cooperate to move portions of and/or supply power or materials to head 16.

Head 16 may be configured to receive or otherwise contain a matrix (shown as M). The matrix may include any type(s) or combination(s) of materials (e.g., a liquid resin, such as a zero-volatile organic compound resin, a powdered metal, etc.) that are curable. Exemplary resins include thermosets, single- or multi-part epoxy resins, polyester resins, cationic epoxies, acrylated epoxies, urethanes, esters, thermoplastics, photopolymers, polyepoxides, thiols, alkenes, thiol-enes, and more. In one embodiment, the matrix inside head 16 may be pressurized (e.g., positively and/or negatively), for example by an external device (e.g., by an extruder, a pump, etc.—not shown) that is fluidly connected to head 16 via a corresponding conduit (not shown). In another embodiment, however, the pressure may be generated completely inside of head 16 by a similar type of device. In yet other embodiments, the matrix may be gravity-fed into and/or through head 16. For example, the matrix may be fed into head 16, and pushed or pulled out of head 16 along with one or more continuous reinforcements (shown as R). In some instances, the matrix inside head 16 may need to be kept cool and/or dark in order to inhibit premature curing or otherwise obtain a desired rate of curing after discharge. In other instances, the matrix may need to be kept warm and/or illuminated for similar reasons. In either situation, head 16 may be specially configured (e.g., insulated, temperature-controlled, shielded, etc.) to provide for these needs.

The matrix may be used to at least partially coat any number of continuous reinforcements (e.g., separate fibers, tows, rovings, socks, and/or sheets of continuous material) and, together with the reinforcements, make up a portion (e.g., a wall) of composite structure 12. The reinforcements may be stored within or otherwise passed through head 16. When multiple reinforcements are simultaneously used, the reinforcements may be of the same material composition and have the same sizing and cross-sectional shape (e.g., circular, square, rectangular, etc.), or a different material composition with different sizing and/or cross-sectional shapes. The reinforcements may include, for example, carbon fibers, vegetable fibers, wood fibers, mineral fibers, glass fibers, plastic fibers, metallic fibers, optical fibers (e.g., tubes), etc. It should be noted that the term “reinforcement” is meant to encompass both structural and non-structural (e.g., functional) types of continuous materials that are at least partially encased in the matrix discharging from head 16.

The reinforcements may be at least partially coated with the matrix while the reinforcements are inside head 16, while the reinforcements are being passed to head 16, and/or while the reinforcements are discharging from head 16. The matrix, dry (e.g., unimpregnated) reinforcements, and/or reinforcements that are already exposed to the matrix (e.g., pre-impregnated reinforcements) may be transported into head 16 in any manner apparent to one skilled in the art. In some embodiments, a filler material (e.g., chopped fibers, nano particles or tubes, etc.) and/or additives (e.g., thermal initiators, UV initiators, etc.) may be mixed with the matrix before and/or after the matrix coats the continuous reinforcements.

One or more cure enhancers (e.g., a UV light, an ultrasonic emitter, a laser, a heater, a catalyst dispenser, etc.) 18 may be mounted proximate (e.g., within, on, and/or adjacent) head 16 and configured to enhance a cure rate and/or quality of the matrix as it is discharged from head 16. Cure enhancer 18 may be controlled to selectively expose portions of structure 12 to energy (e.g., UV light, electromagnetic radiation, vibrations, heat, a chemical catalyst, etc.) during material discharge and the formation of structure 12. The energy may trigger a chemical reaction to occur within the matrix, increase a rate of the chemical reaction, sinter the matrix, harden the matrix, solidify the matrix, polymerize the matrix, or otherwise cause the matrix to cure as it discharges from head 16. The amount of energy produced by cure enhancer 18 may be sufficient to cure the matrix before structure 12 axially grows more than a predetermined length away from head 16. In one embodiment, structure 12 is at least partially cured before the axial growth length becomes equal to an external diameter of the matrix-coated reinforcement.

The matrix and/or reinforcement may be discharged together from head 16 via any number of different modes of operation. In a first example mode of operation, the matrix and/or reinforcement are extruded (e.g., pushed under pressure and/or mechanical force) from head 16 as head 16 is moved by support 14 to create features of structure 12. In a second example mode of operation, at least the reinforcement is pulled from head 16, such that a tensile stress is created in the reinforcement during discharge. In this second mode of operation, the matrix may cling to the reinforcement and thereby also be pulled from head 16 along with the reinforcement, and/or the matrix may be discharged from head 16 under pressure along with the pulled reinforcement. In the second mode of operation, where the reinforcement is being pulled from head 16, the resulting tension in the reinforcement may increase a strength of structure 12 (e.g., by aligning the reinforcements, inhibiting buckling, equally loading the reinforcements, etc.) after curing of the matrix, while also allowing for a greater length of unsupported structure 12 to have a straighter trajectory. That is, the tension in the reinforcement remaining after curing of the matrix may act against the force of gravity (e.g., directly and/or indirectly by creating moments that oppose gravity) to provide support for structure 12.

The reinforcement may be pulled from head 16 as a result of head 16 being moved by support 14 away from an anchor (e.g., a print bed, a previously fabricated surface of structure 12, a fixture, etc.) 20. For example, at the start of structure formation, a length of matrix-impregnated reinforcement may be pulled and/or pushed from head 16, deposited against anchor 20, and at least partially cured, such that the discharged material adheres (or is otherwise coupled) to anchor 20. Thereafter, head 16 may be moved away from anchor 20, and the relative movement may cause the reinforcement to be pulled from head 16. In some embodiments, the movement of reinforcement through head 16 may be selectively assisted via one or more internal feed mechanisms, if desired. However, the discharge rate of reinforcement from head 16 may primarily be the result of relative movement between head 16 and anchor 20, such that tension is created within the reinforcement. As discussed above, anchor 20 could be moved away from head 16 instead of or in addition to head 16 being moved away from anchor 20.

Head 16 may include, among other things, an outlet 22 and a matrix reservoir 24 located upstream of outlet 22. In one example, outlet 22 is a single-channel outlet configured to discharge composite material having a generally circular, tubular, or rectangular cross-section. The configuration of head 16, however, may allow outlet 22 to be swapped out for another outlet that simultaneously discharges multiple channels of composite material having the same or different shapes (e.g., a flat or sheet-like cross-section, a multi-track cross-section, etc.). Fibers, tubes, and/or other reinforcements may pass through matrix reservoir 24 (e.g., through one or more internal wetting mechanisms located inside of reservoir 24) and be wetted (e.g., at least partially coated, encased, and/or fully saturated) with matrix prior to discharge.

One or more controllers 34 may be provided and communicatively coupled with support 14 and head 16. Each controller 34 may embody a single processor or multiple processors that are programmed and/or otherwise configured to control an operation of system 10. Controller 34 may include one or more general or special purpose processors or microprocessors. Controller 34 may further include or be associated with a memory for storing data such as, for example, design limits, performance characteristics, operational instructions, tool paths, and corresponding parameters of each component of system 10. Various other known circuits may be associated with controller 34, including power supply circuitry, signal-conditioning circuitry, solenoid driver circuitry, communication circuitry, and other appropriate circuitry. Moreover, controller 34 may be configured to communicate with other components of system 10 via wired and/or wireless transmission.

One or more maps may be stored within the memory of controller 34 and used during fabrication of structure 12. Each of these maps may include a collection of data in the form of lookup tables, graphs, and/or equations. In the disclosed embodiment, controller 34 may be programmed to use the maps and determine movements of head 16 required to produce desired geometry (e.g., size, shape, material composition, performance parameters, and/or contour) of structure 12 and/or to regulate operation of support 14, cure enhancer(s) 18, and/or other related components in coordination with the movements.

It has been found that, while fabricating structures 12 having a high-aspect ratio (i.e., high ratio of height in a Z-direction to a dimension in an X- and/or Y-direction), a small base, intricate features, etc., the structures 12 can become unstable. For example, forces exerted in the X- and/or Y-direction via the reinforcement extending between structure 12 and print head 16 and/or being pulled out of head 16 and in a direction away from structure 12 can cause the structure 12 to flex, bend, and/or break away from a desired location. This movement can cause misalignment between reinforcements of overlapping layers and other inaccuracies, thereby limiting an overall height of structure 12 that can be printed.

As shown in FIG. 1, controller 34 may be programmed to cause print head 16 to fabricate one or more support tethers 36 that extend from structure 12 to a surface 38. In some instances, surface 38 is a build platform on which structure 12 is being fabricated. It is contemplated, however, that surface 38 could be another surface (e.g., a ceiling, a side wall, etc.) of a print chamber in which structure 12 is being fabricated.

In one exemplary embodiment, multiple tethers 36 are utilized to simultaneously connect structure 12 (e.g., at a given height H in the Z-direction) to surface 38. In this embodiment, the multiple tethers 36 may together form one or more (e.g., nested) hollow frustoconical support shells 40 that at least partially (e.g., fully) surrounds structure 12 during fabrication of structure 12. It should be noted that support shells 40 of other shapes may alternatively be formed via the multiple tethers 36, if desired.

In the depicted embodiment, each support shell 40 may have a base that at least partially (e.g., fully) encircles a corresponding base of structure 12 at surface 38, and a top that at least partially (e.g., fully) encircles structure 12 at the particular Z-height H away from the base. The base of each support shell 40 may not touch structure 12, but be spaced a distance r away from a center (e.g., a center axis) 42 of structure 12. The top of each support shell 40 may adhere to or at least touch structure 12. If multiple support shells 40 (e.g., shells 40 having different heights H and/or radiuses r) are utilized, the shells 40 may be nested inside each other. That is, an innermost support shell may have a smallest r and/or H, and an outermost support shell may have a largest r and/or H.

Tethers 36 may be fabricated by extending continuous reinforcements from the desired Z-height of structure 12 to surface 38, or vice versa. This extension could occur as structure 12 reaches the desired Z-height or at any time after the height of structure 12 surpasses the desired Z-height.

In an alternative embodiment, rather than tethers extending in an inclined Z-direction (e.g., inclined relative to surface 38 and/or axis 42), support shells 40 could be built up via overlapping layers of discharge in circles of decreasing diameters. These overlapping layers may be fabricated simultaneously with structure 12 or fabricated only after structure 12 has reached the desired Z-height. For example, controller 34 may cause print head 16 to fabricate a single layer of each required support layer sequentially before or following fabrication of a single layer of structure 12. In this way, the cone shapes of all support shells 40 build in height in the Z-direction at a same rate as structure 12. Alternatively, multiple layers of structure 12 may first be fabricated, followed by some or all of the layers of one or more of the required support shells 40 (or vice versa). For example, structure 12 may be fabricated to a first height, followed by fabrication of a first support shell 40 to the first height, followed by additional fabrication of structure 12, followed by fabrication of a second support shell 40.

The number of supports shells 40 required to adequately support structure 12, as well as the r and H of each shell 40 may be determined by controller 34 (or another controller, for example an offboard CAD modeler—not shown) and correspond with characteristics of structure 12. For example, controller 34 may determine a force to be applied to structure 12 by print head 16 (e.g., via tension within the reinforcement extending between print head 16 and structure 12) during fabrication of each layer. Controller 34 may then determine the r and H required of a particular support (e.g., tether 36 and/or shell 40) to counteract the forces, such that fabrication commences as desired (e.g., such that a currently discharging layer aligns properly with an underlying layer, and such that structure 12 does not lean, bend, warp, or wobble more than a threshold amount). Controller 34 may also consider geometry (e.g., symmetry and overhang) of structure 12, and how the forces applied by print head 16 and/or gravity may create moments that should be countered by support tethers 36 and/or shells 40. Controller 34 may determine a threshold height in the Z-direction at which the forces imparted by print head 16 on structure 12 cause undesired results, and ensure that tethers 36 and/or the top of a suitable support shell 40 contact structure 12 at a height H lower than or the same as the threshold height.

As briefly discussed above, each supports shell 40 may not be limited to having a symmetrical conical shape. For example, the outer shape of support shell 40 could conform to an outer shape of structure 12 (e.g., with a decreasing radial offset in the Z-direction). It is also contemplated that support shell 40 may not be centered about an axis of structure 12 or any other particular feature. For example, support shell 40 could be skewed in a particular direction, if desired. Finally, it is contemplated that tethers 36 and support shells 40 could be fabricated from the same materials as structure 12 (e.g., for simplicity in fabrication), or from materials (e.g., from matrix only) that are easier to remove from structure 12 and/or surface 38 after fabrication is complete.

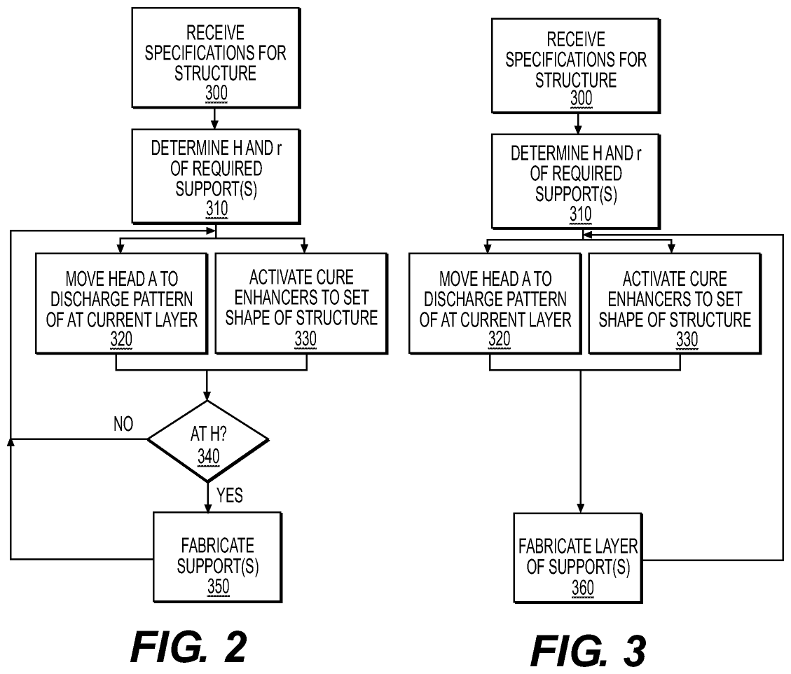

FIGS. 2 and 3 are flowcharts depicting exemplary methods performed by controller 34 during operation of system 10. These figures will be discussed in more detail in the following section to further illustrate the disclosed concepts.

### INDUSTRIAL APPLICABILITY

The disclosed system may be used to manufacture composite structures having any desired shape and size. The disclosed system may be particularly useful in manufacturing composite structures having a high-aspect ratio. The composite structures may be fabricated from any number of different fibers of the same or different types and of the same or different diameters, and any number of different matrixes of the same or different makeup. Operation of system 10 will now be described in detail, with reference to FIGS. 2 and 3.

At a start of a manufacturing event, information regarding a desired structure 12 may be loaded into system 10 (e.g., received by controller 34 that is responsible for regulating operations of system 10—Step 300). This information may include, among other things, a size (e.g., diameter, wall thickness, length, etc.), a contour (e.g., a trajectories, surface normal, etc.), surface features (e.g., ridge size, location, thickness, length; flange size, location, thickness, length; etc.), connection geometry (e.g., locations and sizes of couplings, tees, splices, etc.), reinforcement selection and specification, matrix selection and specifications, discharge locations and conditions, curing specifications, etc. It should be noted that this information may alternatively or additionally be loaded into system 10 at different times and/or continuously during the manufacturing event, if desired.

The component information may then be used by controller 34 to determine a number of supports required to adequately support structure 12, as well as specifications for each of the supports (Step 310). These specifications may include, for example a number of tethers 36, a number of shells 40, a height H at which tethers 36 and/or shells 40 should engage structure 12, a radius r at which tethers 36 and/or shells 40 should engage surface 38, a method of shell fabrication (e.g., via tethers 36 or overlapping concentric layers—if used), a material of tethers 36 and/or shells 40 (e.g., matrix only, matrix coated reinforcements, and a same matrix and/or reinforcements as structure 12 or other), etc.

Controller 34 may then regulate operations of system 10 to fabricate structure 12. For example, the in-situ wetted reinforcements may be pulled and/or pushed from outlet 22 of head 16 as support 14 selectively moves head 16 relative to anchor 20 (e.g., based on known kinematics of support 14, head 16, and anchor 20 and based on desired geometry of structure 12), such that the resulting structure 12 is fabricated as desired (Step 320). At this same time, controller 34 may be programmed to selectively activate one or more of cure enhancers 18 to expose the material discharging from outlet 22 of head 16 to cure energy (Step 330). As indicated above, this cure energy may be sufficient to completely cure the matrix within the material or sufficient to cure only an outer surface of the material, allowing the material to maintain its form during infill of support material 28 around and/or inside of structure 12.

Controller 34 may further be programmed to determine if the just-discharged layer of structure 12 is at or has surpassed the predetermined layer height H (Step 340). In the embodiment of FIG. 2, when the just-completed layer of structure 12 is not yet at or has not yet surpassed the predetermined layer height H (Step 340:N), controller 34 may loop back to Steps 320 and 330 and continue fabricating structure 12 normally.

However, when controller 34 determines at Step 340 that the just-discharged layer of structure 12 is at or has surpassed the predetermined layer height H (Step 340:Y), controller 34 may instead interrupt the normal fabrication of structure 12 and instead initiate fabrication of the predetermined support(s) (Step 350). Once fabrication of the predetermined support(s) has been completed, normal fabrication of structure 12 may recommence until either fabrication of structure 12 has been completed or until the height of structure 12 reaches a next higher predetermined height H corresponding to an additional and surrounding support.

FIG. 3 illustrates an alternative method, wherein any required shell(s) 40 are fabricated at the same time that structure 12 is fabricated. The method of FIG. 3 includes identical steps 300-330. Following initial completion of steps 320 and 330, however, a layer of the required shell(s) 40 may be discharged before returning to and repeating Steps 320 and 330.

As discussed above, multiple benefits may be associated with the disclosed system. For example, structure 12 may be supported throughout fabrication with material 28 that is easily separated from structure 12 (e.g., cut or broken away) when fabrication is complete. This may allow fabrication of high-aspect ratio structures, as well as delicate structures (e.g., structures with overhangs, small bases, thin lattices, etc.). In addition, more intricate and/or thorough curing of structure 12 may be implemented, without having to move structure 12 from where it was fabricated. This may help ensure higher material properties, with enhanced structural accuracies.

It will be apparent to those skilled in the art that various modifications and variations can be made to the disclosed system. Other embodiments will be apparent to those skilled in the art from consideration of the specification and practice of the disclosed system. It is intended that the specification and examples be considered as exemplary only, with a true scope being indicated by the following claims and their equivalents.

What is claimed is:

1. An additive manufacturing system, comprising:
a support;
a platform;
a print head connected to and moveable by the support, the print head configured to discharge a material onto the platform to build up a structure in an axial direction away from the platform; and
a controller in communication with the support and the print head, the controller being programmed to:
determine a threshold height of the structure in the axial direction at which continued discharge of the material from the print head will cause the structure to deviate from a desired location in a radial direction that is orthogonal to the axial direction; and
coordinate operation of the print head with operation of the support to fabricate at least one support that extends away from the structure at the threshold height to resist deviation of the structure from the desired location in the radial direction.

2. The additive manufacturing system of claim 1, wherein the at least one support is a tether.

3. The additive manufacturing system of claim 2, wherein:
the controller is further configured to determine an angle relative to the axial and radial directions at which the tether should extend away from the structure to support forces in the radial direction generated with the structure during fabrication of the structure at the threshold height; and
coordinate operation of the print head with operation of the support to fabricate the tether to extend away from the structure at the angle.

4. The additive manufacturing system of claim 3, wherein the tether extends from the threshold height of the structure to the platform at a radial distance greater than zero away from the structure.

5. The additive manufacturing system of claim 2, wherein the at least one support includes a plurality of tethers that together form a hollow shell around the structure.

6. The additive manufacturing system of claim 5, wherein the hollow shell has a frustoconical shape.

7. The additive manufacturing system of claim 5, wherein the plurality of tethers together form a plurality of nested hollow shells.

8. The additive manufacturing system of claim 1, wherein the at least one support includes at least one hollow shell formed around the structure.

9. The additive manufacturing system of claim 8, wherein the at least one hollow shell includes a plurality of nested hollow shells.

10. The additive manufacturing system of claim 1, wherein the controller is programmed to coordinate operation of the print head with operation of the support to fabricate the at least one support only when an actual height of the structure in the axial direction at least one of reaches or surpasses the threshold height.

11. The additive manufacturing system of claim 1, wherein the controller is programmed to coordinate operation of the print head with operation of the support to fabricate a layer of the at least one support between fabrication of layers of the structure.

12. The additive manufacturing system of claim 1, further including a cure enhancer configured to expose the material to a cure energy that causes the material to harden, wherein the controller is programmed to coordinate operation of the print head and the cure enhancer with operation of the support to discharge and harden at least a layer of the structure before fabrication of the at least one support.

13. The additive manufacturing system of claim 12, wherein the material includes a continuous reinforcement at least partially coated with a curable matrix.

14. The additive manufacturing system of claim 13, wherein the at least one support is fabricated from only the curable matrix.

15. A method of additively manufacturing a structure, comprising:
discharging a material from a print head onto a platform to build up the structure in an axial direction away from the platform;
determining a threshold height of the structure away from the platform at which continued discharging of the material from the print head will cause the structure to deviate in a radial direction from a desired location, the radial direction being orthogonal to the axial direction;
causing the print head to fabricate at least one support that extends away from the structure at the threshold height to resist deviation of the structure in the radial direction.

16. The method of claim 15, wherein causing the print head to fabricate the at least one support includes causing the print head to fabricate a tether.

17. The method of claim 16, wherein:
further including determining an angle relative to the platform at which the tether should extend away from the structure to support radial forces generated with the structure during fabrication of the structure at the threshold height; and
causing the print head to fabricate the tether includes causing the print head to extend the tether from the threshold height to the platform at the angle.

18. The method of claim 16, wherein causing the print head to fabricate the tether includes causing the print head to fabricate a plurality of tethers that together form a shell around the structure.

19. The method of claim 15, wherein causing the print head to fabricate the at least one support includes causing the print head to fabricate the at least one support only when an actual height of the structure at least one of reaches or surpasses the threshold height.

20. The method of claim 15, wherein:
causing the print head to fabricate the at least one support includes causing the print head to fabricate a layer of the at least one support between fabrication of layers of the structure; and
fabricating each of the layers of the structure includes exposing the material to a cure energy that causes the material to harden before subsequent fabrication of the at least one support.
